(19) United States
(12) Patent Application Publication
(10) Pub. No.: US 2009/0177485 A1
(43) Pub. Date: Jul. 9, 2009

(54) METHOD OF ESTABLISHING INTERPERSONAL RELATIONS, AND SUITABLE DEVICE TO IMPLEMENT SUCH A METHOD

(75) Inventor: Roberto Braga, Gallarate(Varese) (IT)

Correspondence Address: Pearne & Gordon LLP, 1801 East 9th Street, Suite 1200, Cleveland, OH, 44114-3108, US

(73) Assignee: MARISA DI VARALLI MARISA & C. S.A.S., 21013 GALLARATE (VA) (IT)

(21) Appl. No.: 12/278,619

(22) PCT Filed: Dec. 13, 2006
(86) PCT No.: PCT/IB06/03601

§ 371 Date: Aug. 7, 2008

(30) Foreign Application Priority Data
Feb. 10, 2006 (IT) MI2006A000234

(51) Int. Cl. G06Q 90/00

(52) U.S. Cl. 705/1; 455/41.2

(57) ABSTRACT

A method of establishing interpersonal relations comprises emission by a first user of an availability signal, reception of a correlation signal by a potential conversation partner, and establishment of a mutual assent for a meeting between the first user and the potential conversation partner; the step of establishing the mutual assent comprises a sub-step of determining a margin time for the reply within which the correlation signal can be received by the transceiver device of the first user

The present invention relates to a method of establishing interpersonal relations, and in particular first meetings between two or more users of a device allowing the method to be put into practice.

It is known that finding new friends or establishing sentimental relations between unknown persons is often made difficult by shyness and/or by the fact that it is not possible to know beforehand with certitude whether a given “new” person wishes to get in contact with other persons or not.

In order to help search and contact among people that typically can be found in social/public circles such as bars, discotheques and others, different types of electronic devices have been conceived the task of which is exactly that of helping in identifying an individual (of any sex) that, within a given social circle, is disposed to make friends or meet people, and which can even be able to find individuals having given cultural and/or aesthetic and/or physical preferences and so on. For instance, from U.S. Pat. No. 4,173,016 it is known a “signalling system for interpersonal introduction” consisting of a transmitter and a series of receivers (owned by different persons, respectively) in which anyone who wishes to “express” his/her preferences, inputs suitable commands on the transmitter and sends them to all the receivers present and, among the latter, only those that have been set on the same “preferences” accept transmission and send a reply signal. In this known technique, a user receiving a message can leave an automatic reply or manually operate his/her transponder after receiving a “compatible” signal.

This first known embodiment, while being rather refined from the point of view of the ability to identify a so-called “compatible partner”, also has some drawbacks.

In fact, the great structural complexity of each receiver-transmitter (in the following “transceiver”) involves important manufacturing and sale costs, that are not adapted to promote spreading of the article itself (that should be mainly used by adolescent or young people, that therefore do not have a particular financial independence). At the same time, the modalities to be adopted by each user of this known device to enter the respective personal preferences greatly reduce the degree of user friendliness, and from a strictly technical point of view it is to be pointed out that in order to be able to communicate properly, two devices must be able to establish a free “sight line” between them, which practically forces the users themselves to eliminate the possibility of remaining anonymous still before being able to receive a signal from a “compatible” person. It is further to be noted that in this system of known type, the recognition or identification condition and therefore the “agreement condition to interpersonal communication” relies on transceiver devices that emit signalling in an automatic manner and out of the true (instantaneous!) will of the users.

To eliminate part of the above mentioned drawbacks, the Applicant has conceived a different method for interpersonal communications which is based on at least one pair of transceiver devices (each of which is associated with a user); these devices comprise means for transmitting a signal to, and means for receiving a signal from another device, as well as means adapted to establish a simultaneous agreement or assent given by the users (and not as in the above described example, an agreement established in an automatic manner by the devices themselves). In other words, in this embodiment of the Applicant the transceiver devices are much simpler and cheaper (as they do not necessarily store and/or transmit qualitative signals, but they only send a “presence” signal in an environment), and in addition the true putting into effect of the situation of “mutual acquaintance” takes place only if both users, exactly at that given time instant, have operated the “simultaneous-assent means”, therefore acting of their own will, and not being dependent on default settings.

The last-mentioned invention too is not however without drawbacks, which drawbacks are mainly connected with the fact that while on the one hand the great structural and functional simplification enables a drastic reduction in costs (and therefore promotes spreading of the devices among the public, and also makes their use very simple), the necessity to operate each of the two devices simultaneously greatly reduces the possibility of really giving rise to a meeting between two or more persons. It is to be noted in this respect that the “simultaneous assent” involves that the two users engaged in the process must operate the simultaneous assent means at least for the time required for transmitting their own signal and, at the same time, for the time necessary to receive the other people's signal; in other words, this means that two or more persons that are in the same social circle may feel interest in each other but, even if they utilise the Applicant's invention, they are not sure they will succeed in getting in contact with each other.

The Applicant has therefore developed a further method of interpersonal communications duly based on an assembly of at least two transceiver devices and aiming at solving the above described drawbacks.

More particularly, it is an aim of the present invention to implement a method enabling to combine the requirement of establishing an interpersonal relation in an optimal manner with at least one “unknown” person, with the requirement of remaining anonymous as far as the certitude exists of having really identified a person who has proved his/her intention to accept approaches.

The technical task mentioned and the aims specified are substantially achieved by a method of establishing interpersonal communications and by a device usable for implementing said method, having the features recited in one or more of the appended claims.

Description of some preferred but not exclusive embodiments of a method in accordance with the invention and a device usable in said method is now given hereinafter by way of non-limiting example. The device is illustrated in the accompanying drawings, in which:

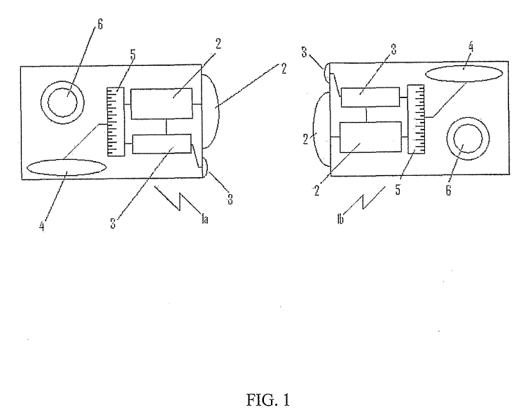

FIG. 1 is a circuit diagram of a pair of devices in accordance with the invention, located in the same environment.

The method of interpersonal communications implemented by the present invention is essentially based on emission by a first user of an availability signal; this availability signal is generated by a first transceiver device 1a and is spread in an environment or social circle in which at least another user is present (who in turn will be provided with a similar device that for the sake of clarity will be identified as the “second device” and denoted with 1b in the figure).

The availability signal sent by the first device 1a is received by the second device (or more generally, it can be received by all devices 1 present in that social circle or environment, if it is an “omni-directional” signal), and at this point it is possible for the first user who has started the intercommunication process, to receive a correlation signal from a potential conversation partner; to the ends of the present invention for “potential conversation partner” it is intended a person that is in the same social circle as the first user, is provided with a device 1 and has received the availability signal.

On receiving the correlation signal, it is possible to establish a mutual assent to the meeting between the first user and the potential conversation partner, and in the same manner as in the preceding patent in the name of the Applicant, this condition of establishing the mutual assent preferably takes place through simultaneous signalling on both transceiver devices 1a and 1b associated with the first user and the potential conversation partner, respectively.

Advantageously, the step of establishing the mutual agreement comprises a sub-step of determining a margin time for the reply during which the correlation signal can be received from the first transceiver device 1a of the first user.

Now it is to be noted that, unlike known devices, the present invention is not based on the automatic establishment (and simultaneous signalling on both the intercommunicating devices) of the agreement on the part of the electronics of the individual devices, neither is it operatively limited by the requirement of acting personally and at the same time instant on the devices themselves.

On the contrary, the present invention is based on the fact that each user is put in a condition to exploit a “time window” within which he/she can decide on his/her own initiative, to reply to an availability signal; in this way, the agreement to the contact is given by the user of his/her own will, the user being in any case put in a position to “know in advance” that someone in his/her social circle is looking for interpersonal relations and, by carrying out a simple reply action, he/she is unequivocally brought to a condition to reply only to the person who has sent the availability signal.

A sequence of the operations of the method in accordance with the invention, given by way of example, contemplates the following steps:
emitting by a first user, an availability signal through a first transceiver device 1a;
counting a predetermined waiting time during which the first device 1a is enabled to receive at least one correlation signal;
if during this waiting time the first device 1a receives a correlation signal (by a second transceiver device 1b), a condition of agreement to the contact by a potential conversion partner is notified at least to the first user.

In addition, if the correlation signal is received within the waiting time, it is also possible to send a confirmation signal to the second transceiver device 1b itself.

In turn, sending of the confirmation signal by the first transceiver device 1a can be automatic (and can take place simultaneously with or immediately after reception of the correlation signal), or it can be subordinated to manual and voluntary operation of the device itself by the user.

It is to be noted that at all events sending of the confirmation signal may not correspond or be coincident with the notification of the condition of agreement to the contact, but it is used to prepare both devices (the one that has sent the confirmation signal and the one that has received it) to a possible accomplishment of the agreement that, as seen, is given at the moment chosen by at least one user.

In other words, sending of the confirmation signal enables the second device 1b too (and therefore the user of the second device that from the first user's point of view is then the so-called “potential conversion partner”) to recognise a condition of possible mutual meeting and/or acquaintance.

Sending of the confirmation signal therefore can be followed by a notification to each user of a condition at which both the concerned persons are aware of the fact that someone else has made an attempt to get in contact with them.

In more detail, emission of the confirmation signal can be preceded by the following operating sub-steps:
the occurred reception of the compatibility signal is signalled to the first device 1a, in use to the first user (and at this point the two devices of the two users have communicated with each other but not yet emitted any notification to the respective proprietors);
a limit time for the reply starting from reception of the compatibility signal is counted at least on the device that has received the confirmation signal (and that was the first to send the availability signal at the beginning of the whole process);
at this point the first user decides whether he/she will manually send the confirmation signal within expiry of the above mentioned limit time for the reply.

In the different embodiments described above (and therefore irrespective of the confirmation signal being sent), the present method can come to and end with a notification step on both transceiver devices 1a and 1b that a condition of mutual assent and/or compatibility between the first user and the potential conversation partner has been reached; this notification can be directed at least to the first user and preferably can be also directed to the potential conversation partner, at the same time or at a different time depending on current requirements.

According to the technical means that can be installed in device 1, this notification can take place through suitable visual and/or audible and/or luminous and/or vibrating interfaces.

For more accuracy in operation, the present method can advantageously further comprise sending of an identification information at least from the first user to the potential conversation partner and/or from the potential conversation partner to the first user; this operating step is substantially coincident with the step of transmitting the compatibility signal, while sending of the identification information from the potential conversation partner to the first user is preferably coincident with said step of receiving the correlation signal.

In short, this identification information from the first user to the potential conversation partner allows recognition of the device that, among a great number of them, has really emitted an availability signal and therefore prevents the device owned by the potential conversation partner from being put “in contact” with possible other devices that are present in the same social circle but have not been operated.

It is to be noted that in accordance with the invention this identification information will not be made known to each of the two subjects engaged in the process but they will be only internally processed by the transceiver devices; to this end, in an embodiment of the present method it is provided that the identification information should consist of a possibly coded and/or encrypted alphameric code that is unequivocally allocated to a given device 1.

Still for the purpose of being able to distinguish various “replies” that can come from as many potential “conversation partners”, the present method can further comprise a step of chronological indexing of sequences of signals received from at least one second device 1b.

Consistently with that which has been said beforehand, these received signals may comprise either the already mentioned correlation signals (that are emitted from at least one second device 1b by a voluntary potential conversation partner and that advantageously can carry the already mentioned alphameric identification code unequivocally associated with a given transceiver device 1), or specific “reception notices”.

These particular “reception notices” are automatically emitted from at least one second device 1b in reply to emission of an availability signal (or better, in reply to the occurred reception by the second device 1b itself); in other words, the present method can further comprise a step of sending a reception notice which is generated on occurrence of the true reception of the availability signal and therefore automatically comes from the second device 1b, being finally received (still in an automatic manner) by the first device 1a.

Due to implementation of the reception notices, it is also possible to go on carrying out the method only in those cases in which the availability signal has really reached a “target” device, thus avoiding a useless waste of resources.

The indexing step substantially comprises a first sub-step of storing an identification code coming from a second device 1b (which in turn will be able to be conveniently carried by means of a correlation signal or the already mentioned reception notice), and a subsequent sub-step of allocating the identification code to a memory area; this memory area will correspond to a given ordinal number so that an information connection is carried out between the time succession of the received signals.

It is to be noted that by virtue of said indexing, it is possible to keep a trace of the potential contacts; in fact, if the first user emits a given number of signals and receives the same or a different number of correlation signals in reply (or also only of reception notices!), he/she all the same has at his/her disposal, information useful to establish potential interpersonal contacts and he/she may even come to “discover” who among the different potential conversation partners has signalled his/her availability.

Conveniently, the present method can also comprise a step of counting a number of availability signals emitted and/or a number of correlation signals received; this counting step can be further followed by a step of displaying this number to the user of device 1 (through a suitable interface such as an LCD panel or a series of light emitting diodes or LEDs).

In order to increase easiness of mutual contact between the two users, above all when the social circle is particularly crowded or direct conversations are particularly difficult therein, the present method may further comprises a step of sending qualitative and/or numeric data at least from the first user to the potential conversation partner; sending of this qualitative and/or numeric data is conditional and preferably coincident with the step of establishing the mutual assent and therefore does not allow either user (the first user and the potential conversation partner) to accede to the data itself until occurrence of the condition of mutual assent to the contact.

Depending on current requirements, the contents of this qualitative and/or numeric data can be of any kind and of any intelligible form (text strings, voice messages, graphic elements); typically, in a preferred embodiment of the present invention it will be a telephone number.

Finally, with reference to the limit time for the reply characterising the present method, it is possible to provide a step of cancelling the received signals and/or the identification information on expiry of said time limit for the reply; in this manner, if the first user and/or the potential conversation partner within the established time do not wish to go on any further in establishing a real and true interpersonal contact, the data relating to the “preliminary steps” of the method (that are managed in an independent manner by the electronics of the devices into play!) are eliminated as they are clearly useless for subsequent operation of the devices themselves.

It is also an object of the present invention a transceiver device 1 usable in the method herein described and claimed in the following claims.

With reference to the drawings, a device 1 usable in the above described method substantially comprises transmission means 2 adapted to emit an availability signal, reception means adapted to receive an availability signal from at least one analogous device (e.g., the second device 1b discussed during description of the method) located in the same environment, and/or a correlation signal from a potential conversation partner, and in addition signalling means adapted to notify a mutual agreement or assent condition to a meeting between the first user and the potential conversation partner.

Advantageously, this device 1 comprises counting means to calculate a margin time for the reply, which means is operatively active on the transmission means and/or the reception means and/or the signalling means so that they are configured in a reversible manner between an enable condition at which they can transmit and/or receive and/or notify said mutual assent and a condition of interruption at which on the contrary they cannot be operated.

Conveniently, operability of the device is ensured by a suitable interface 6 operable by the first user and/or the possible conversation partner; this interface can consist of a button or at all events of any other operating device presently available.

In other words, the counting means quantifies a maximum time, to be set in an arbitrary manner depending on the user's requirements or merely established on assembling of the device, within which the device itself can really notify the assent condition to contact. As already explained, this reply time can be calculated either starting from emission of an availability signal or starting from reception of a confirmation signal.

It is to be noted that, in order to ensure the use repeatability of the device in accordance with the present invention, on expiry of the reply time the device can be in any case configured to the enable condition, so as to enable the user to send a new availability signal.

In addition, in order to ensure an efficient signal transmission, the transmission means can utilise different technologies presently available (transmission via radio and/or infrared rays or other) and at the same time suitable storage elements can be mounted within the devices themselves which are adapted to store the identification codes of the devices themselves and/or the numeric/personal data of a user.

It is finally to be pointed out that, depending on current requirements, the devices 1 usable in the present invention can be such constructed that they are independent and separate items or can be inserted or even integrated into complex items (such as palm computers or mobile phones).

In order to optimise the energy consumption of the device 1, on/off means may be present which can be activated on the electric/electronic circuitry of device 1.

The invention achieves many advantages.

In fact, due to the particular construction architecture of device 1, the manufacturing costs are very low even when the device is integrated into the onboard electronics of more complex devices (such as palm computers and/or mobile phones and so on), and at the same time an optimal result in terms of “establishment of the communication” can be ensured with a minimum degree of qualitative and quantitative complexity of the transmitted signal.

At the same time it will be appreciated that a suitable choice of the transmission means makes it possible to operate the devices 1 also from “concealed” positions (such as at the inside of garment pockets or bags), which will give a further guarantee of anonymity to the users.

In addition, due to the above described implementation forms, each of the two users involved in trying to find a situation of mutual communication can have a time margin within which, depending on his/her will, can give his/her assent to communication without necessarily losing the trace of an occurred request of communication and therefore without losing the possibility of getting in contact with the other user.

Finally, it will be recognised that the present invention can be used with great facility by any user, since previous complicated programming operations are not present and the interface through which the user makes device 1 operational is very simple.

1. A method of establishing interpersonal communications between at least two users, comprising the following steps:
emitting an availability signal by a first user, by means of a first transceiver device (1a) in an environment or social circle in which at least another user is present;
receiving a correlation signal by a potential conversation partner, said potential conversation partner having received said availability signal through a second transceiver device (1b); and
establishing a mutual agreement or assent to a meeting between said first user and potential conversation partner, said condition of establishing the mutual assent preferably taking place through simultaneous signalling on both transceiver devices (1a, 1b) associated with the first user and the potential conversation partner, respectively, characterised in that said step of establishing the mutual assent comprises a sub-step of determining a margin time for the reply within which said correlation signal can be received by the first transceiver device (1a) of the first user.

2. A method as claimed in claim 1, comprising the following steps:
emitting an availability signal by a first user, by means of a first transceiver device (1a);
counting a predetermined waiting time within which said first device (1a) is enabled to receive at least one correlation signal;
conditionally on receiving a correlation signal by a second transceiver device (1b) within said waiting time, notifying to the first user, an agreement condition to contact on the part of a potential conversation partner.

3. A method as claimed in claim 1, characterised in that it further comprises a step of sending a confirmation signal to the second transceiver device (1b), said sending of the confirmation signal being preferably conditional on reception of the correlation signal.

4. A method as claimed in claim 3, characterised in that said step of sending the confirmation signal is carried out automatically by the first transceiver device (1a), preferably simultaneously with or immediately after reception of the correlation signal.

5. A method as claimed in claim 3, characterised in that said step of sending the confirmation signal comprises the following sub-steps:
signalling the occurred reception of the compatibility signal to the first user;
counting a limit time for the reply starting from reception of the compatibility signal;
manually sending the confirmation signal, on the part of the first user, within expiry of said limit time for the reply.

6. A method as claimed in claim 1, characterised in that it further comprises a step of notifying a condition of mutual assent and/or compatibility between the first user and the potential conversation partner on both the transceiver devices (1a, 1b).

7. A method as claimed in claim 1, characterised in that it further comprises sending of identification information at least from the first user to the potential conversation partner and/or from the potential conversation partner to the first user.

8. A method as claimed in claim 7, characterised in that sending of said identification information is substantially coincident with said step of transmitting the compatibility signal or with said step of receiving the correlation signal.

9. A method as claimed in claim 1, characterised in that it further comprises a step of chronologically indexing sequences of signals received from at least one second device (1b), said received signals preferably comprising reception notices automatically emitted from at least one second device (1b) in reply to emission of an availability signal and/or preferably comprising correlation signals emitted from at least one second device (1b) by voluntary action of a potential conversation partner.

10. A method as claimed in claim 9, characterised in that said indexing step comprises the following substeps:
a sub-step of storing an identification code coming from a second device (1b), said identification code being preferably carried by a correlation signal; and
a sub-step of allocating said identification code to a memory area, said memory area corresponding to a predetermined ordinal number.

11. A method as claimed in claim 1, characterised in that it further comprises a step of sending qualitative and/or numeric data at least from the first user to the potential conversation partner, said step of sending the qualitative and/or numeric data being conditional on, and preferably coincident with said step of establishing the mutual assent.

12. A method as claimed in claim 11, characterised in that said qualitative and/or numerical data is a telephone number.

13. A method as claimed in claim 1, characterised in that it comprises a step of counting a number of availability signals emitted and/or a number of correlation signals received, the method preferably comprising the step of displaying this number to a user of the device (1).

14. A method as claimed in claim 1, characterised in that it further comprises a step of cancelling the received signals and/or the identification information on expiry of the limit time for the reply.

15. A device for interpersonal communication adapted to implement a method as claimed in claim 1, comprising:
transmission means (2) adapted to emit an availability signal;
reception means (3) adapted to receive an availability signal from at least one second device (1b) located in the same environment and/or a correlation signal on the part of a potential conversation partner; and
signalling means (4) adapted to notify a condition of mutual assent to a meeting between said user and the potential conversation partner, characterised in that it further comprises counting means (5) for calculating a margin time for the reply, which means is operatively active on the transmission means (2) and/or the reception means (3) and/or the signalling means (4) for configuration of same in a reversible manner between an enable condition at which they can transmit and/or receive and/or notify said mutual assent and a condition of interruption at which on the contrary they are not operable.
